(19) United States
(12) Patent Application Publication
(10) Pub. No.: US 2014/0040011 A1
(43) Pub. Date: Feb. 6, 2014

(54) WEB BASED PAY PER CLICK PERFORMANCE GRADER

(71) Applicant: Larry Kim, Cambridge, MA (US)

(72) Inventor: Larry Kim, Cambridge, MA (US)

(73) Assignee: WORDSTREAM, INC., Boston, MA (US)

(21) Appl. No.: 13/567,474

(22) Filed: Aug. 6, 2012

(51) Int. Cl. G06Q 30/02

(52) U.S. Cl. 705/14.43

(57) ABSTRACT

A performance grader tool for performing evaluation of an advertising campaign is provided that includes a reporting module that receives campaign data associated with the advertising campaign and performs one or more selective metric-base analysis on the campaign data and produces metric-based data used in evaluating the advertising campaign. The reporting module selectively displays the metric-based data in a plurality of reporting formats to the user.

### BACKGROUND OF THE INVENTION

The invention is related to the field of Pay-Per-Click (PPC) marketing, and in particular a web-based Pay-Per-Click (PPC) advertising tool that performs an instant evaluation of an advertiser's account program.

Pay-Per-Click (PPC) marketing, also known as Search Engine Marketing (SEM) or simply, Paid Search, is a technique of advertising on Search Engines such as Google, Bing and Yahoo. PPC Marketing provides advertisers with a means to promote their websites by increasing their visibility in the sponsored listings section of a Search Engine Results Page (SERF), which are ads located both along the top and side of the page

In PPC Marketing, advertisers must create PPC campaigns which specify (for example): (1) Lists of keywords that advertisers are interested in bidding on; (2) Ads to display when search engine users conduct searches on those keywords; (3) Maximum cost per click (CPC) bid—the most an advertiser is willing to pay if a search engine user clicks on an advertiser's ad.

Achieving success at Search Engine Marketing is challenging due to the inherent, highly competitive nature of searching—advertisers must develop high performing PPC advertising campaigns which then compete against those of other advertisers, in hopes of obtaining the largest possible share of a limited inventory of available impressions, as well as the most prominent ad positions, all at the lowest possible price.

As a result of technical and competitive factors, Search Engine Marketing campaigns require ongoing campaign maintenance and optimization work. For example: (1) Selecting more relevant keywords; (2) Eliminating or filtering out non-relevant keywords; (3) Writing more engaging and relevant ads & landing pages; (4) Managing keyword bids to maximize ROI; (5) Leveraging Search Engine Marketing best practices, such as tracking conversions, or the like.

The success (or failure) of a Search Engine Marketing campaign is largely determined by how effectively an advertiser is able to develop and optimize PPC campaigns that achieve high relevancy scores from the Search Engine Marketing platforms (which are then rewarded with more prominent ad positioning and a lower cost per click), and how well those campaigns compete against those of other advertisers.

### SUMMARY OF THE INVENTION

According to one aspect of the invention, there is provided a performance grader tool for performing evaluation of an advertising campaign. The performance grader tool includes a reporting module that receives campaign data associated with the advertising campaign and performs one or more selective metric-base analysis on the campaign data and produces metric-based data used in evaluating the advertising campaign. The reporting module selectively displays the metric-based data in a plurality of reporting formats to the user.

According to another aspect of the invention, there is provided a method of evaluating an online advertising campaign. The method includes receiving campaign data associated with the user and performs one or more selective metric-base analysis on the campaign data and producing metric-based data used in evaluating the advertising campaign using a reporting module. The reporting module selectively displays the metric-based data in a plurality of reporting formats to the user using the reporting module.

### BRIEF DESCRIPTION OF THE DRAWINGS

FIG. 1 is a schematic diagram illustrating how the inventive performance grader tool authenticates a user;

FIG. 2 is a schematic diagram illustrating an advertiser achieving a Category Score for the Quality Score section used in accordance with the invention;

FIG. 3 is a table illustrating the criteria used to categorize advertisers used in accordance with the invention;

FIG. 4 is a schematic diagram illustrating the Overall Score used in accordance with the invention;

FIG. 5 is a schematic illustrating an Account Summary section having several key elements of an advertiser's performance grader tool report card used in accordance with the invention;

FIG. 6 is a schematic diagram illustrating a Wasted Spend Section of the performance grader tool report card used in accordance with the invention;

FIG. 7 is a schematic diagram illustrating a Click-Through Rate Section of the performance grader tool report card 10 used in accordance with the invention;

FIG. 8 is a schematic diagram illustrating an Impression Share Section of the performance grader tool report card used in accordance with the invention;

FIG. 9 is a schematic diagram illustrating a Quality Score Section of the performance grader tool report card used in accordance with the invention;

FIG. 10 is a schematic diagram illustrating an Account Activity Section of the performance grader tool report card used in accordance with the invention;

FIG. 11 is a schematic diagram illustrating an Ad Text Optimization section of the performance grader tool report card used in accordance with the invention;

FIG. 12 is a schematic diagram illustrating Landing Page Optimization Section of the performance grader tool report card used in accordance with the invention;

FIG. 13 is a schematic diagram illustrating Long-Tail Keyword Optimization Section of the performance grader tool report card used in accordance with the invention;

FIG. 14 is a schematic diagram illustrating the PPC Best Practices section of the performance grader tool report card used in accordance with the invention;

FIG. 15 is a schematic diagram illustrating a Call to Action section of the performance grader tool report card used in accordance with the invention; and

FIG. 16 is a schematic diagram illustrating report card sharing options used in accordance with the invention.

### DETAILED DESCRIPTION OF THE INVENTION

This invention is a web-based Pay-Per-Click (PPC) advertising tool that performs an instant evaluation of an advertiser's paid search campaigns. The invention describes a performance grader tool where an advertiser must furnish their account login credentials, which enables the performance grader tool to programmatically download an advertiser's PPC campaign data (via an Application Program Interface provided by the Search Engine Platform vendors). Next, the performance grader tool performs a detailed analysis and evaluation of the PPC campaign data.

A detailed report card is generated within an average of 20 seconds generated. It provides a complete account audit, including an overall account score, as well as individual scores for different categories, pertaining to PPC advertising key performance metrics, such as: (1) Wasted PPC Spend Analysis; (2) Impression Share; (3) Click Through Rate; (4) Quality Score; (5) Account Activity; (6) Keyword Optimization; (7) Landing Page Optimization; (8) Ad Text Optimization; and (9) Adherence to Industry Best Practices. Note the invention allows for additional metrics beside those described herein.

A novel aspect of the invention is that it is a programmatic PPC account grading application. Another novel aspect of the invention pertains to the use of a relative benchmarking/scoring system that is employed throughout the performance grader tool, for computing the advertiser's scores for the overall account as well as the individual categories.

Similar to how the SAT provides an absolute score as well as a percentile score to demonstrate how the student's test results compare to those of other students, as a measure of peer comparison, the performance grader tool grades an advertiser's achievement relative to the scores of others, similar advertisers that have recently used the performance grader tool.

The competitive benchmarking system (for example, grading of accounts relative to peer advertisers) that is employed by the performance grader tool provides more accurate insights into true campaign performance because the scoring mechanism encapsulates the competitive nature of Paid Search Marketing, wherein success is largely dependent on competitive factors.

The data contained in a performance grader tool report card provides advertisers with detailed information on the relative strengths and weaknesses of their advertising campaign, providing actionable insights that are simply not available to advertisers by any other means, because they do not have access to the actual campaign performance data of their competitors.

The performance grader tool is a fully automated, software-based PPC marketing grading system. While several other companies offer free PPC campaign audits, none are fully automated. There are 2 types of existing PPC account offerings available on the market today, manual and questionnaire-based.

In a manual PPC account audit, a PPC consultant is given access to an advertiser's account data, manually logs into the a system, downloads various account metrics, and then formats the data into a report or spreadsheet which is then sent back to the advertiser.

The manual PPC account analysis approach is inferior to an automated PPC account analysis because the analysis takes hours, days or weeks to process. The performance grader tool, on the other hand, automatically connects to an account and programmatically downloads PPC campaign and performance data (via the Google AdWords API). A report is calculated on-the-fly, and on average, takes just 20 seconds to generate.

Other so-called PPC audit tools are based on requiring that the advertiser manually complete a questionnaire. For example: (1) What is your Monthly Budget? (2) How many clicks do you get on average per month from PPC? (3) What is your estimated average cost per click? (4) What is your estimated average conversion rate? (5) What is your average profit per conversion?

Based on the answers provided by an advertiser, these types of tools will automatically generate a report. However this “questionnaire” based approach is inferior to an automated PPC account analysis because it relies on the advertiser correctly and accurately recalling and self-reporting PPC account performance data, a process that is error-prone and time-consuming. Furthermore, the analysis of the tool is limited to analyzing the few data fields that were contained in the questionnaire and there is no comparison to peers in the same spend range/industry. The invention can use com thousands of other runs of the PPC Grader to make comparisons. Something not possible by manual means.

By contrast, the fully-automated approach employed by the performance grader tool does not require the advertiser to answer any campaign performance questions, since that data is automatically downloaded by establishing an Application Program Interface (API) connection to the Search Engine Marketing Platform, and analyzed via the performance grader tool, which downloads and analyzes every aspect of a PPC account, including the following data reports, going back 90-days:

The data contained in these reports describe every technical detail of an advertiser's search engine marketing campaigns, down to every keyword, ad, date, time, user search query, location, cost, and outcome (etc.) of every click that ever occurred within an advertiser's PPC account, and often measures in the 10's or 100's of megabytes of PPC account information—this level of granular detail far surpasses the amount of information that could ever be collected via a questionnaire-based grading tool.

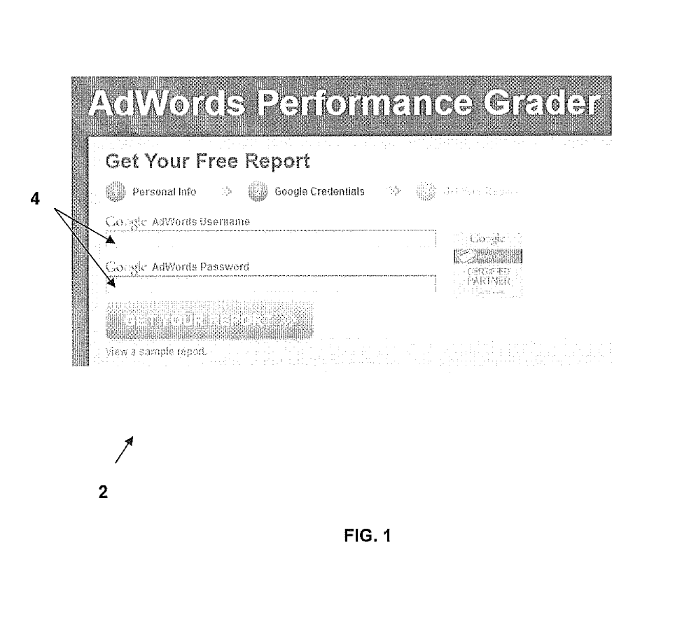

FIG. 1 illustrates how the performance grader tool 2 asks for a user's account credentials 4, and then downloads volumes of PPC account data directly from the Search Engine Marketing Platform Provider via an API, as opposed to asking a user to fill out a questionnaire about their PPC Campaign.

The aforementioned, fully-automated PPC analysis system requires that an advertiser grant the performance grader tool access to their account, in order to download and analyze PPC campaign performance data. To accomplish this, the performance grader tool utilizes two Secure Account Login mechanisms: (1) the advertiser provides account login credentials 4—A user provides the email address and password associated with the account that they would like to evaluate; (2) the advertiser grants account access via OAuth—The performance grader tool 2 also supports the industry standard OAuth authentication protocol, which allows advertisers to approve access to their account without sharing their password.

For both account login mechanisms, the performance grader tool 2 employs secure 256-bit, SSL-based encryption which is the current industry standard way for securing communications over HTTP however other types of security based encryption can be used.

A critical, unique and novel aspect of the invention pertains to the performance grader tool's use of a relative benchmarking/scoring system that is employed to grade advertiser performance in a way that accurately reflects the underlying competitive aspect of Search Engine Marketing. It is similar to how an SAT or credit score rating employs a percentile ranking score to make it possible to easily contextualize how an individual's Raw Score compares to the scores of other test takers within the system.

The competitive benchmarking system (i.e. grading of accounts relative to an advertiser's peers) employed by the performance grader tool provides more accurate insights into true campaign performance because the scoring mechanism encapsulates the competitive nature of Search Engine Marketing, wherein success is largely dependent on competitive factors.

The data contained in a performance grader tool report card provides advertisers with detailed information on the relative strengths and weaknesses of their advertising campaign (relative to an advertiser's peers), providing actionable insights and data that is simply not available to advertisers from Search Engine Platform Providers, such as Google, Bing or Yahoo, or through any other means (because they do not have access to the actual campaign performance data of other, similar advertisers to benchmark themselves against).

Therefore, for each section of the performance grader tool report, such as “Quality Score,” a Raw Score is first computed (for example, a volume-weighted average quality score, which is a score from 0-10). A Category Score for the “Quality Score” section of the report is then calculated by comparing the advertiser's Raw Score against the raw scores of other similar advertisers that have been graded in the past, and then expressed as a percentile ranking.

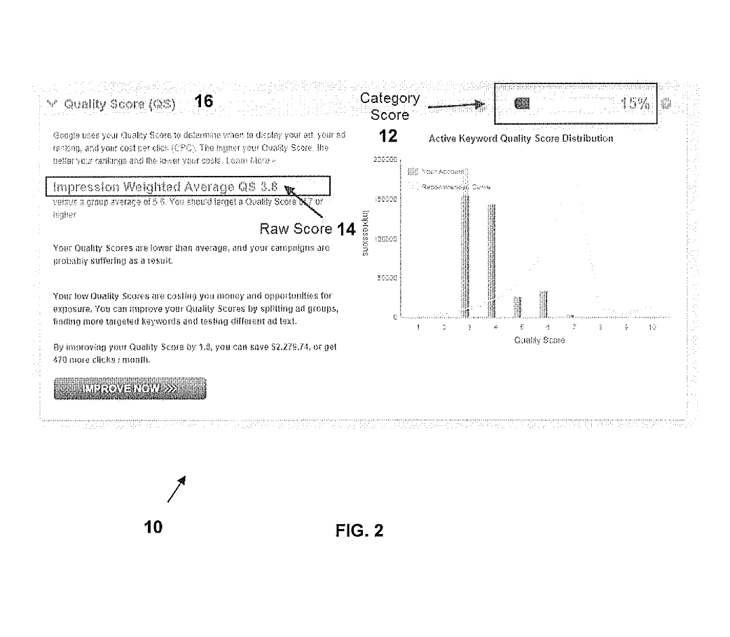

FIG. 2 shows an advertiser achieving a Category Score 12 of 15% for the Quality Score section 16 of the performance grader tool report card 10, based on their Impression Weighted Average Quality Score 14 of 3.8 (which is their Raw Score for this category). The Category Score 12 of 15% means that 85% of similar advertisers achieved higher raw scores, whereas 14% of advertisers achieved lower raw scores.

A key aspect of the Competitive Benchmarking system employed by the performance grader tool 10 is its ability to segment different types of advertisers into different buckets of similar advertisers, and not simply compare advertiser accounts against every other advertiser in the system. This is similar to how real estate agents compare prices of comparable houses (for example, houses with similar size, location, and amenities) or how championship boxing uses different weight classes for different types of fighters (for example: Heavyweight, Welterweight, Flyweight, etc.). The ability to segment the pool of advertisers by different characteristics to ensure relevancy is key to enabling a relevant comparison.

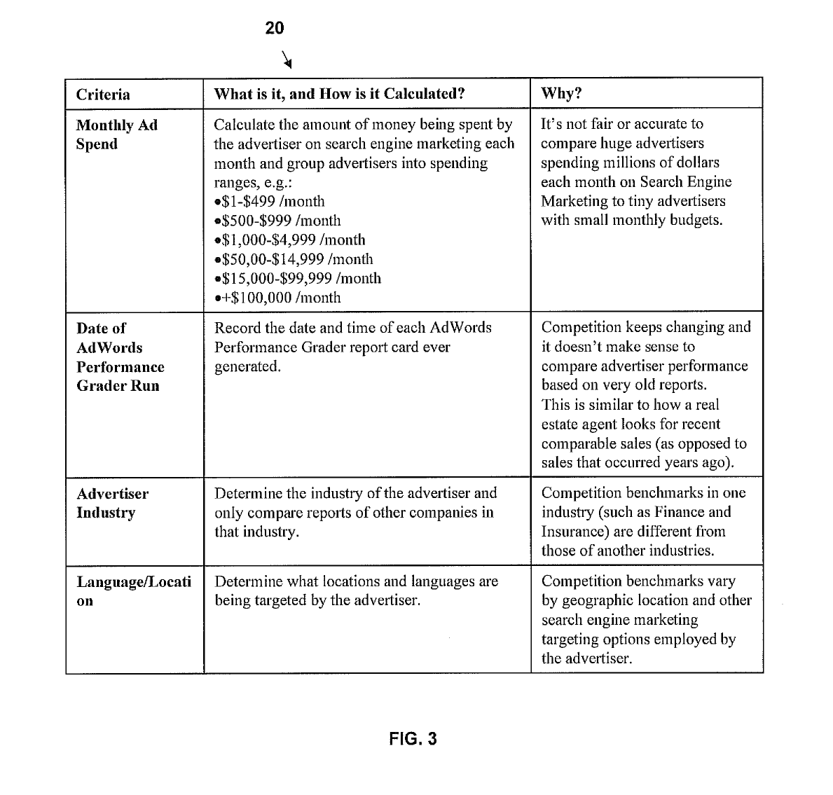

Therefore, the performance grader 10 tool buckets advertisers into categories based on the following criteria, as shown in table 20 of FIG. 3, in order to ensure that a relevant comparison is being made.

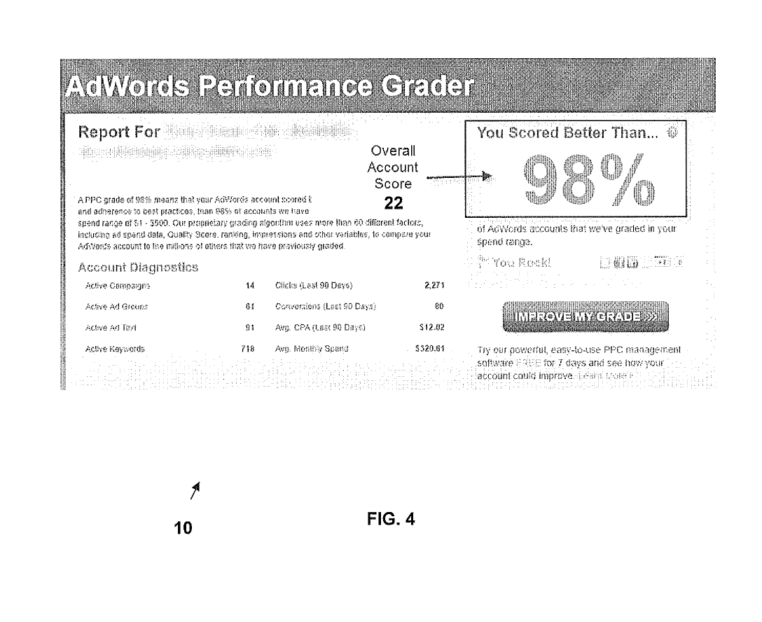

The Overall Account Score 22 is simply a weighted average of the various Category Scores 12 contained within the report card 10, as shown in FIG. 4.

The performance grader tool Competitive Benchmarking methodology benefits from an important network effect—the more reports it grades, the more accurate, relevant, and useful those reports are.

The following is a detailed description of all the components contained in each section of the performance grader tool report card. Each section of the performance grader tool report includes the following components: (1) Category Name—The key metric being graded; (2) Raw Score—A metric that measures actual achievement for the key metric being analyzed: (3) Graph or Table—A visual element that helps contextualize the Raw Score: (4) Category Score—The Competitive Benchmarking score for the category, expressed as a percentile ranking; (5) Estimated Impact—An impact analysis that describes how much money could be saved or how many additional clicks could be acquired if the advertiser's performance was improved;

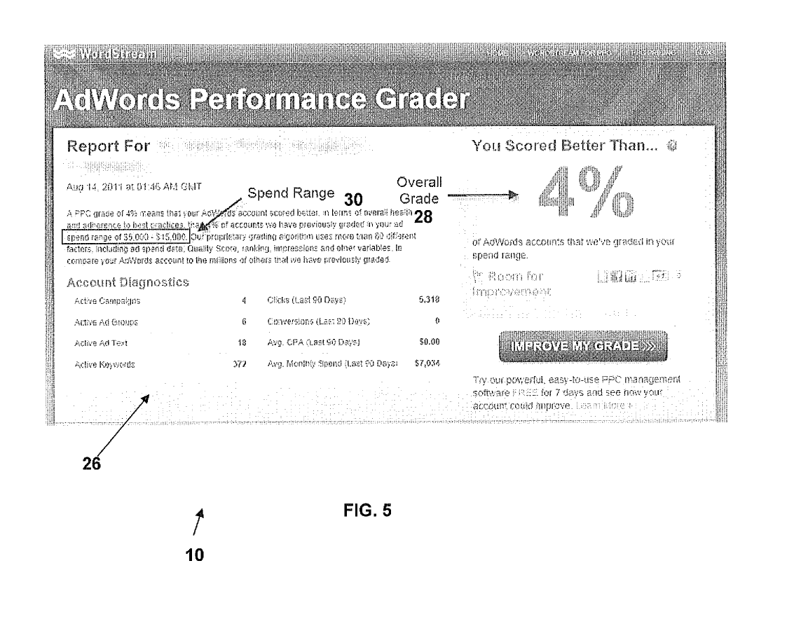

FIG. 5 shows a Account Summary section 26 having several key elements of the advertiser's performance grader tool report card 10. In particular, the Account summary section 26 includes Description of the Advertiser's Peers field 30 that shows that this advertiser is only being compared with other advertisers spending between $5,000-$15,000/month. The Overall Account Score field 28 that is a weighted average of the individual category scores contained in the body of the report. A Generic Account Diagnostics field 26 that includes account information, having Average Monthly Spend, Number of Active Keywords, or the like.

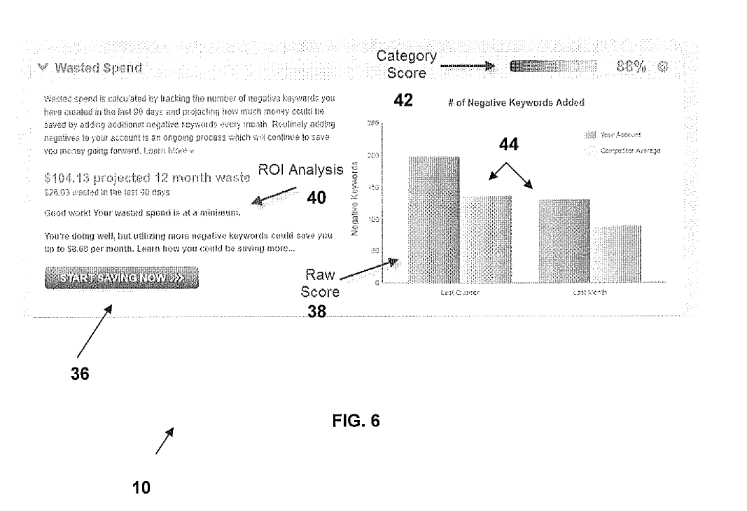

FIG. 6 illustrates a Wasted Spend Section 36 of the performance grader tool report card 10. The Wasted Spend section 36 is a reflection of the advertiser's ability to reduce irrelevant clicks through the use of Negative Keywords, which are an important feature of Search Engine Marketing that allows an advertiser to specify exclusionary keywords which prevent their ads from showing up on irrelevant searches. The Raw Score field 38 for the Wasted Spend section 36 is calculated by counting the number of negative keywords added to the advertiser's account in the last month and in the last quarter. A Bar Chart 44 plots the Advertiser's Category Raw Score 38 (the number of negative keywords added in the account over the last month and the last quarter) and compares it to the average number of negative keywords added in other similar accounts, over the same time range. A Category Score 42 expresses the advertiser's Raw Score 38 relative to the scores of other, similar advertisers, as a percentile. The ROI Analysis section 40 summarizes an analysis and highlights potential savings that could be realized if an advertiser decided to take action and optimize the account to reduce Wasted Spend.

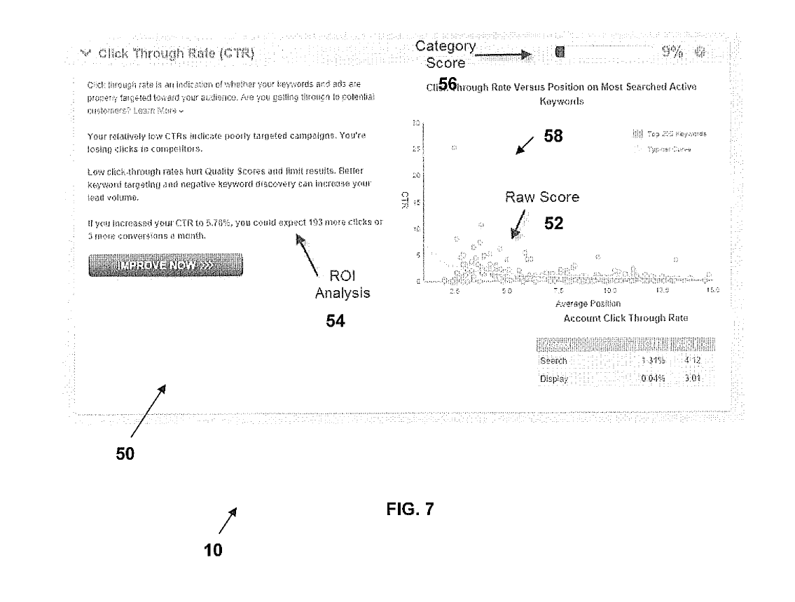

FIG. 7 shows a Click-Through Rate Section 50 of the performance grader tool report card 10. The Click-Through Rate section 50 on the performance grader tool report card 10 provides insight into an advertiser's ability to create engaging and relevant PPC advertising campaigns. Great ad campaigns have higher click-through rates (CTR) whereas poorly constructed ad campaigns have low CTRs. The Raw Score 52 for the Wasted Spend section 36 is calculated by analyzing the CTR for the top 200 keywords in the advertiser's account. An X-Y Chart 58 plots the CTRs for the top 200 keywords vs. the average ad position for each keyword. The ad position is the order in which an ad shows up on a page. For example, an ad position of “2” means that the ad, on average, occupied the second ad spot on a page. Also plotted on the chart 58 is the expected average click-through rate at each ad position. The Category Score 56 expresses the advertiser's Raw Score 52 relative to the scores of other, similar advertisers, as a percentile. The ROI Analysis section 54 summarizes an analysis and highlights potential number of incremental clicks and conversions that could be realized if an advertiser decided to take action and optimize the account to improve Click-Through Rates.

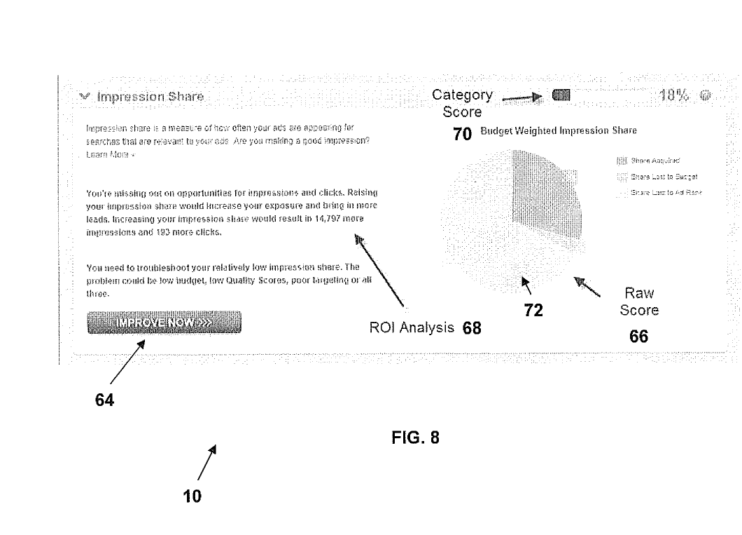

FIG. 8 illustrates an Impression Share Section 64 of the performance grader tool report card. The Impression Share section 64 on the performance grader tool report card 10 provides insight into an advertiser's ability to acquire a large share of the available search impressions by creating relevant and engaging PPC advertising campaigns. Great ad campaigns earn higher Impression Share whereas poorly constructed ad campaigns are penalized by the Search Engine Marketing platforms with low Impression Shares. A Raw Score 66 for the Impression Share section 64 is calculated by analyzing the advertiser's Impression Share metrics for all of the active campaigns in their account, then performing a weighted average, based on the daily budget assigned to each campaign. A Pie Chart 72 plots the Advertiser's Budget-Weighted Account Impression Share, which shows the Advertiser's Impression Share Acquired, Impression Share Lost due to Budget, and Impression Share lost due to AdRank (which is proportional to ad Relevancy). The Impression Share Category Score 70 expresses the advertiser's Raw Score (the advertiser's Impression Share achievement) relative to the scores of other, similar advertisers, expressed as a percentile. The Impression Share ROI Analysis section 72 summarizes an analysis of the advertiser's impression share metrics and highlights potential increases in impressions and clicks that an advertiser could expect to achieve if the advertiser decided to take action and optimize the account to improve Impression Share Metrics.

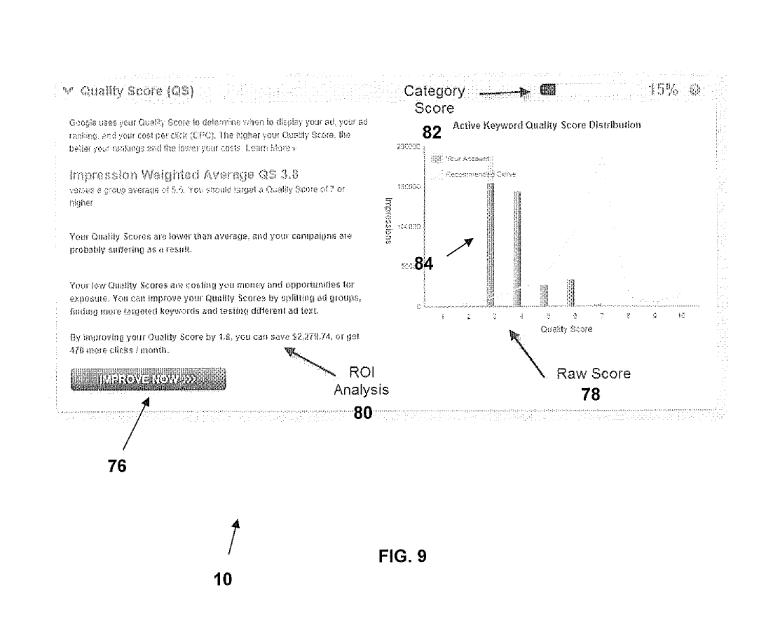

FIG. 9 illustrates a Quality Score Section 76 of the performance grader tool report card 10. The Quality Score section 76 of the performance grader tool report card 10 provides insight into an advertiser's ability to create and execute PPC advertising campaigns that receive high Quality Scores from the Search Engine Marketing platforms. Quality Score is a score from 1-10, which is a measurement given to advertisers by Search Engine Marketing platforms, based on an analysis of the relevancy of an advertiser's PPC marketing campaigns. High performing ad campaigns earn high Quality Scores and are rewarded by Search Engine Marketing platforms with greater Impression Share, more prominent Ad Positions, and lower cost per click, whereas advertiser campaigns with poor Quality Scores are penalized by the Search Engine Marketing platforms and receive low Impression Share, the least prominent ad spots, and higher cost per click.

A Raw Score 78 for the Quality Score section 76 is calculated by analyzing the Quality Scores for every keyword in an advertiser account, then performing a weighted average across the different keywords based on the number of impressions accrued to each keyword. A visual histogram 84 plots the Advertiser's Impression Weighted Quality Score distribution, illustrating the number of keyword impressions accrued at each Quality Score, from 1-10. Additionally, a normal, average Quality Score distribution is overlaid on the histogram in order to provide insight into how the advertiser's Quality Score distribution compares with the average Quality Score distribution. The Quality Score Category 82 is calculated by taking the advertiser's Raw Score (the advertiser's Impression Weighted Quality Score) then comparing it relative to the scores of other, similar advertisers, and expressing the resulting number as a percentile. A Quality Score ROI Analysis section 80 summarizes an analysis of the advertiser's Quality Score metrics and highlights potential increases in clicks, or potential cost savings that an advertiser could expect to achieve if the advertiser decided to take action and optimize the account to address the Quality Score issues that are diagnosed in the report.

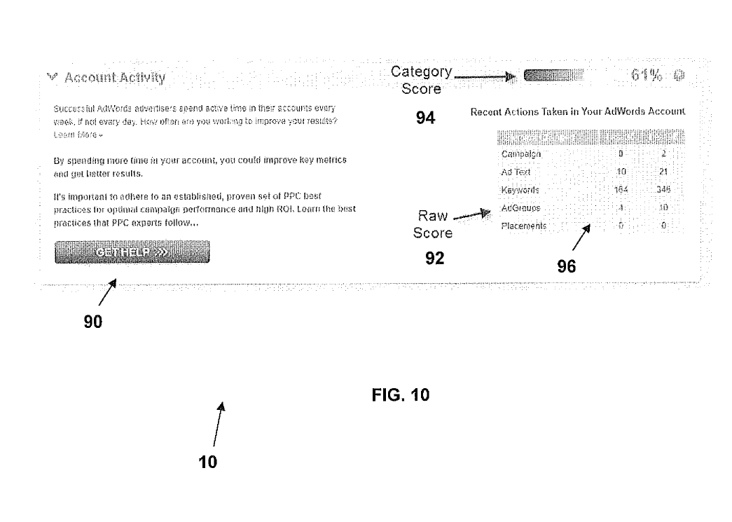

FIG. 10 illustrates an Account Activity Section 90 of the performance grader tool report card 10. An Account Activity section 90 of the performance grader tool report card 10 provides insight into the level of effort being applied by an advertiser towards optimizing and managing their PPC advertising accounts. Due to competitive and technical reasons, PPC advertising campaigns require ongoing time devoted to critical management and optimization efforts. This section allows advertisers to compare their effort level (or lack of effort) to the effort level being applied by other, similar PPC advertisers. On average, PPC advertising campaigns that are being actively managed and optimized are more likely to earn high Quality Scores and achieve better ROI than PPC advertising campaigns that are left in a state of neglect. A Raw Score 92 for the Account Activity section 90 is calculated by downloading the advertiser's account change history log, and analyzing the extent of work conducted in the account over the last month and the last quarter. The performance grader tool counts the number of times that foundational PPC advertising objects, such as keywords, text ads, campaigns, ad groups and placements, are either created, edited or deleted.

The recent account activity is summarized in a table 96 that shows the absolute number of changes made for each type of PPC account object, over the last month and the last quarter. An Account Activity Raw Score 92 is calculated by computing an activity score which applies different weightings to the different PPC account objects and multiplying the weighting factor by the number of changes for that object in the past month and quarter. An Account Activity Category Score 94 expresses the advertiser's Raw Activity Score 92 (which reflects number of changes made, weighted based on the relative importance of the various PPC advertising objects) is compared to the Raw Activity Scores 92 of other, similar advertisers, and expressed as a percentile.

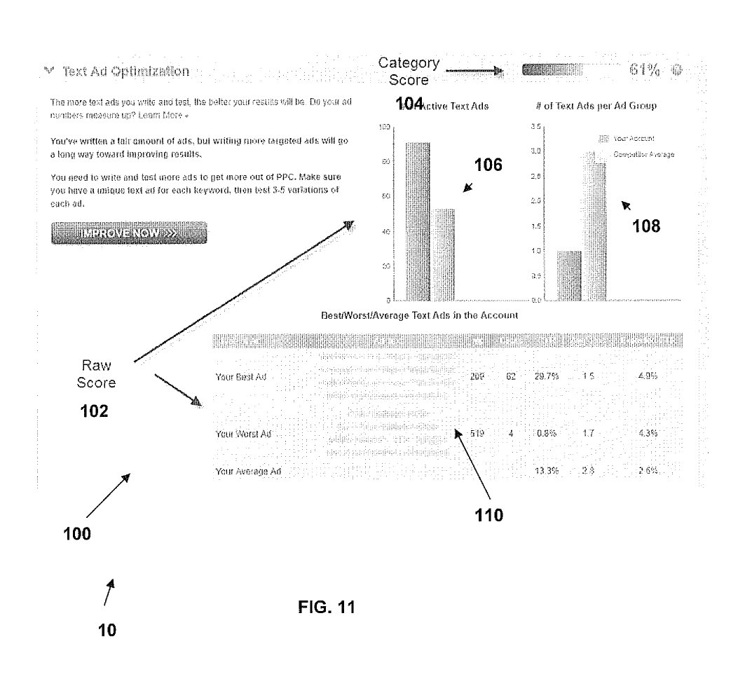

FIG. 11 illustrates an Ad Text Optimization section 100 of the performance grader tool report card 10. The Ad Text Optimization section 100 of the performance grader tool report card 10 provides insight into an advertiser's ability to create and test relevant and engaging Text Ads, which is an important aspect of PPC marketing. Ads that are engaging and relevant are more likely to be clicked on and thus more likely to achieve higher Click-Through Rates than those that are not. Ad text optimization is a combination of several factors, including an advertiser's willingness to create and test different text ads, and the performance of the ads that are created, measured based on Click-Through Rate and other factors. High performing text ads with high Click-Through Rates are rewarded by Search Engine Marketing platforms with greater Impression Share, more prominent Ad Positions, and lower cost per click, whereas text ads with low Click Through Rates are penalized by the Search Engine Marketing platforms and receive low Impression Share, the least prominent ad spots, and higher cost per click.

A Raw Score 102 for the Ad Text Optimization section is calculated by analyzing the total number of active text ads in an advertiser account, as well as the average number of text ads per ad group. These metrics provide insight into an advertisers effort level being applied towards Ad Text Optimization. Additionally, ad text performance metrics, such as click through rate, are analyzed. These Raw Score statistics are visually displayed on the performance grader tool report card 10. First, two bar charts 106, 108 display a comparison of the total number of active Text Ads, and the number of text ads per Ad Group in the advertiser's account, and compares it to the corresponding average values for other, similar advertisers. Additionally, Text Ad performance metrics are summarized in a table 110, which includes an analysis of the advertiser's best and worst ads. The Ad Text Optimization Category Score 104 is calculated by taking the advertiser's Raw Score 102 (the quantity and performance of ads in their account) then comparing it relative to the scores of other, similar advertisers, and expressing the resulting number as a percentile.

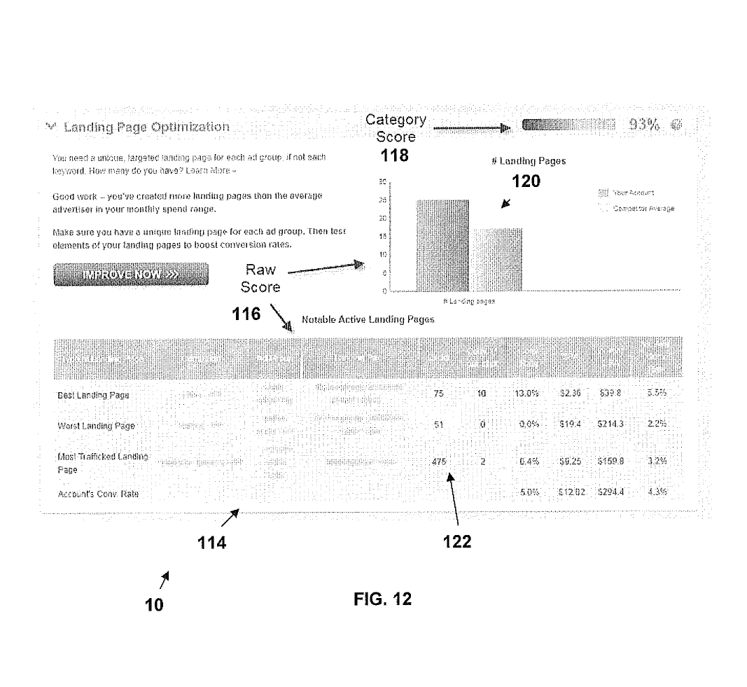

FIG. 12 illustrates Landing Page Optimization Section 114 of the performance grader tool report card 10. The Landing Page Optimization section 114 of the performance grader tool report card 10 provides insight into an advertiser's ability to create and test relevant and engaging Landing Pages, which are the pages to which a user is directed, after clicking on a PPC ad. Landing Page Optimization is an important aspect of PPC marketing. Landing Pages that are more engaging and relevant are more likely to drive desired goal conversion actions (such as a completed sale or contact-us action). Achieving success at Landing Page Optimization is a combination of several factors, including an advertiser's willingness to create and test different Landing Pages, as well as the performance of the Landing Pages that are created, measured based on relevancy, conversion rate metrics, and other factors. Highly relevant Landing Pages which match the theme of the keywords and text ads employed in an advertiser's PPC marketing campaign are rewarded by Search Engine Marketing platforms with greater Impression Share, more prominent Ad Positions, and lower cost per click, whereas landing pages that aren't closely related to an advertiser's keywords and text ads are penalized by the Search Engine Marketing platforms and receive low Impression Share, the least prominent ad spots, and higher cost per click.

A Raw Score 116 for the Landing Page Optimization section is calculated by analyzing the total number of active Landing Pages in an advertiser account. This metric provides insight into an advertisers effort level being applied towards Landing Page Optimization. Additionally, Landing Page performance metrics, such as conversion rates are analyzed. These Raw Score statistics are visually displayed on the performance grader tool report card 10. First, a bar chart 120 compares the total number of active Landing Pages vs. the number of Landing Pages employed by other, similar advertisers. Additionally, Landing Page performance metrics are summarized in a table 122, which includes an analysis of the advertiser's best and worst ads. A Category Score 118 for the Landing Page section is calculated by taking the advertiser's Raw Score 116 (the quantity and performance of Landing Pages in their account) then comparing it relative to the scores of other, similar advertisers, and expressing the resulting number as a percentile.

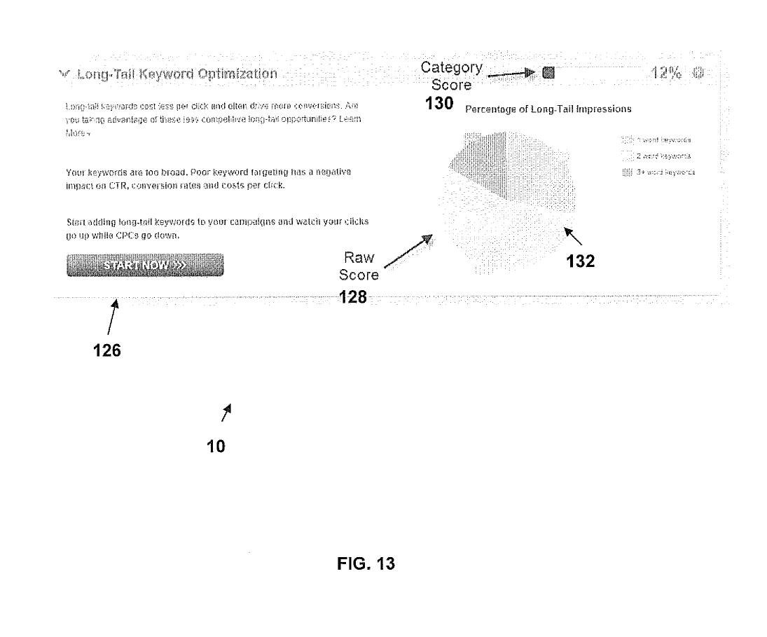

FIG. 13 illustrates Long-Tail Keyword Optimization Section 126 of the performance grader tool report card 10. The Long-Tail Keyword Optimization section 126 of the performance grader tool report card 10 provides insight into an advertiser's ability to effectively exploit Long-Tail Keywords. A Long-Tail Keyword is a type of keyword that is highly specific in nature, consisting of 3+ words (e.g. “Gluten Free Cake Mix”). Long-Tail Keywords often cost less than so-called Head terms (i.e. less specific words, such as “Cake Mix” or “Cake”) due to less advertiser competition. They also drive more conversion actions, due to the more specific intent of the keyword. Long-Tail Keywords have the potential to generate far higher Click-Through Rates, which are then rewarded by Search Engine Marketing platforms with greater Impression Share, more prominent Ad Positions, and lower cost per click. By contrast, Head Terms tend to generate lower Click-Through Rates, which are then penalized by the Search Engine Marketing platforms and receive low Impression Share, the least prominent ad spots, and higher cost per click.

A Raw Score 128 for the Long-Tail Keyword Optimization section is calculated by analyzing the number of ad impressions accrued to the 1-word keywords, 2-word keywords and +3-word keywords in an advertiser's account, then comparing the ratio of impressions accrued to 1-word “head term” keywords vs. the Long-Tail keywords. A pie chart plots 132 the Advertiser's Impression Distribution based on the keyword's word length. The Category Score 130 for the Long-Tail Keyword Optimization Section is calculated by taking the advertiser's Raw Score 128 (the ratio of Head Terms to Long-Tail Terms) and comparing it relative to the scores of other, similar advertisers, and expressing the resulting number as a percentile.

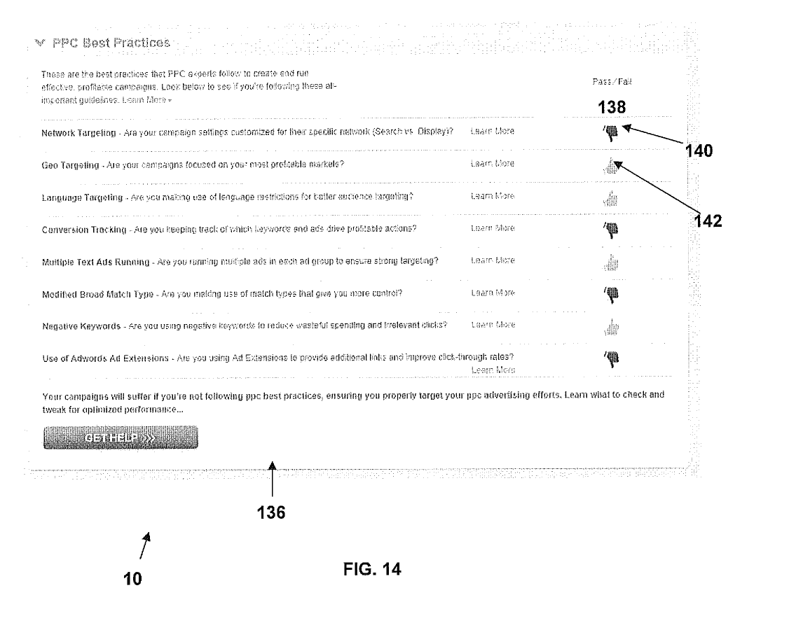

FIG. 14 illustrates The PPC Best Practices section 136 of the performance grader tool report card 10. The PPC Best Practices section 136 checks to see if an account is adhering to PPC Advertising Best Practices by displaying a thumbs-up 142 or a thumbs-down 140 in the pass-fail section 138.

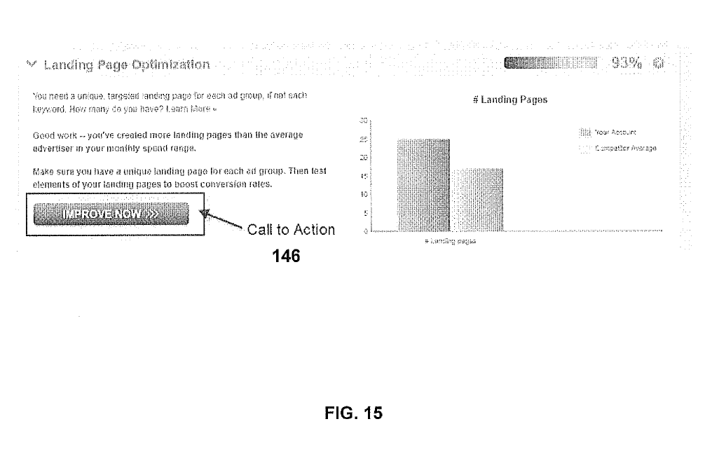

In addition to providing PPC advertisers with a performance grader tool report card 10, the performance grader tool report card 10 can also be an important Marketing Lead-Generation. The performance grader tool report card provides “call-to-action” links 146 within the report such as “Improve my Grade Now” or “Start Saving Now” to encourage users to start a trial of the inventive PPC Management software, as shown in FIG. 15.

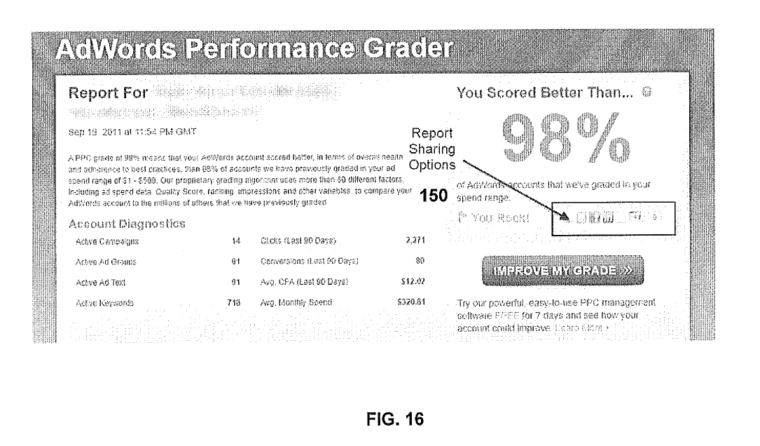

The performance grader tool provides 10 ways to facilitate sharing of an advertiser's report card. In particular, the performance grader tool can be hosted on a site having a particular domain, using a unique URL. An email, containing the unique URL for the user's performance grader tool report card, is emailed to the user when the report is run. The performance grader tool report card 10 provides various report sharing options field 150, including a link to email the report to a friend, and sharing options on social media networks, including Twitter, Facebook, LinkedIn, and Google+, as shown in FIG. 16.

In order to enable continuous usage of the A performance grader tool (i.e. grading of the same AdWords account over time), if an advertiser grades an AdWords account that is already in the system, the AdWords Performance Grader provides an additional report which employs a slightly different scoring methodology. The Raw Scores are graded relative to that advertiser's previous AdWords Performance Grader evaluations, rather than relative to a pool of “similar advertisers.” By providing this additional report, an advertiser can therefore benchmark their achievement in comparison to how they were doing when they previously ran the AdWords Performance Grader.

The performance grader tool in this exemplary embodiment of the invention is platform independent and can execute in any browser such as Firefox®, Internet Explorer®, or Chrome®. The web application can also be written in any platform independent-base computer language, such as Java or the like. The performance grader tool executes on a client computer using a processor or the like. The performance grader tool can be stored in the RAM or ROM of the client. The web application 30 can be stored in the RAM or ROM of the client. Furthermore, performance grader tool can be stored on an external memory device to be uploaded to the client computer for execution.

The devices that can execute the performance grader tool can include, for example, a computer, a computer with a browser device, a telephone, an IP phone, a mobile device (for example, cellular phone, personal digital assistant (PDA) device, laptop computer, electronic mail device), and/or other communication devices. The browser device includes, for example, a computer (for example, desktop computer, laptop computer, mobile device) with a world wide web browser (for example, Microsoft® Internet Explorer® available from Microsoft Corporation, Mozilla® Firefox available from Mozilla Corporation).

Although the present invention has been shown and described with respect to several preferred embodiments thereof, various changes, omissions and additions to the form and detail thereof, may be made therein, without departing from the spirit and scope of the invention.

What is claimed is:

1. A performance grader tool for performing evaluation of an advertising campaign comprising a reporting module that receives campaign data associated with the advertising campaign and performs one or more selective metric-base analysis on the campaign data and produces metric-based data used in evaluating the advertising campaign, the reporting module selectively displays the metric-based data in a plurality of reporting formats to the user.

2. The performance grader tool of claim 1 further comprising a competitive benchmarking system employed by the performance grader tool to segment different types of advertisers into different sets of similar advertisers.

3. The performance grader tool of claim 1, wherein the reporting module comprises an Account summary section that determines how to compare one or more advertisers.

4. The performance grader tool of claim 2, wherein reporting module comprises a Wasted Spend section that determines the ability of the advertiser to reduce irrelevant clicks through the use of Negative Keywords.

5. The performance grader tool of claim 2, wherein the reporting module comprises a Click-Through Rate section that provides insight into an advertiser's ability to create engaging and relevant pay-per click (PPC) advertising campaigns

6. The performance grader tool of claim 2, wherein the reporting module comprises an Impression Share section that provides insight into an advertiser's ability to acquire a large share of the available search impressions by creating relevant and engaging pay-per click (PPC) advertising campaigns.

7. The performance grader tool of claim 2, wherein the reporting module comprises a Quality Score section that provides insight into an advertiser's ability to create and execute pay-per click (PPC) advertising campaigns that receive relatively high Quality Scores from the Search Engine Marketing platforms.

8. The performance grader tool of claim 2, wherein the reporting module comprises an Account Activity section that provides insight into the level of effort being applied by an advertiser towards optimizing and managing their pay-per click (PPC) advertising accounts

9. The performance grader tool of claim 2, wherein the reporting module comprises an Ad Text Optimization section that provides insight into an advertiser's ability to create and test relevant and engaging Text Ads.

10. The performance grader tool of claim 2, wherein the reporting module comprises a Landing Page Optimization section that provides insight into an advertiser's ability to create and test relevant and engaging Landing Pages.

11. The performance grader tool of claim 2, wherein the reporting module comprises a Long-Tail Keyword Optimization section that provides insight into an advertiser's ability to effectively exploit Long-Tail Keywords.

12. The performance grader tool of claim 2, wherein the reporting module comprises a pay-per click (PPC) Best Practices section that checks to see if an account is adhering to PPC Advertising Best Practices.

13. A method of evaluating an online advertising campaign comprising:
receiving campaign data associated with the user and performs one or more selective metric-base analysis on the campaign data using a reporting module; and
producing metric-based data used in evaluating the advertising campaign using a reporting module, the reporting module selectively displays the metric-based data in a plurality of reporting formats to the user using the reporting module.

14. The method of claim 13 further comprising providing a competitive benchmarking system employed by the method to segment different types of advertisers into different sets of similar advertisers.

15. The method of claim 14, wherein the reporting module comprises an Account summary section that determines how to compare one or more advertisers.

16. The method of claim 14, wherein reporting module comprises a Wasted Spend section that determines the ability of the advertiser to reduce irrelevant clicks through the use of Negative Keywords.

17. The method of claim 14, wherein the reporting module comprises a Click-Through Rate section that provides insight into an advertiser's ability to create engaging and relevant pay-per click (PPC) advertising campaigns

18. The method of claim 14, wherein the reporting module comprises an Impression Share section that provides insight into an advertiser's ability to acquire a large share of the available search impressions by creating relevant and engaging pay-per click (PPC) advertising campaigns.

19. The method of claim 14, wherein the reporting module comprises a Quality Score section that provides insight into an advertiser's ability to create and execute pay-per click (PPC) advertising campaigns that receive relatively high Quality Scores from the Search Engine Marketing platforms.

20. The method of claim 14, wherein the reporting module comprises an Account Activity section that provides insight into the level of effort being applied by an advertiser towards optimizing and managing their pay-per click (PPC) advertising accounts

21. The method of claim 14, wherein the reporting module comprises an Ad Text Optimization section that provides insight into an advertiser's ability to create and test relevant and engaging Text Ads.

22. The method of claim 14, wherein the reporting module comprises a Landing Page Optimization section that provides insight into an advertiser's ability to create and test relevant and engaging Landing Pages.

23. The method of claim 14, wherein the reporting module comprises a Long-Tail Keyword Optimization section that provides insight into an advertiser's ability to effectively exploit Long-Tail Keywords.

24. The method of claim 14, wherein the reporting module comprises a pay-per click (PPC) Best Practices section that checks to see if an account is adhering to PPC Advertising Best Practices.
